(19) United States
(12) Patent Application Publication
(10) Pub. No.: US 2016/0026309 A1
(43) Pub. Date: Jan. 28, 2016

(54) CONTROLLER

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/738,243

(22) Filed: Jun. 12, 2015

(30) Foreign Application Priority Data
Jul. 25, 2014 (CN) 201410360029.0
Jul. 25, 2014 (CN) 201410360046.4
Jul. 25, 2014 (CN) 201410361549.3
Jul. 25, 2014 (CN) 201410361716.4

(51) Int. Cl. G06F 3/047; G09G 5/00; G09G 3/32; G06F 3/044

(52) U.S. Cl. CPC G06F 3/047; G06F 3/044; G09G 5/003; G09G 3/3208; G09G 2300/0404

(57) ABSTRACT

In a shadeless touch hand-held electronic device, a touch-sensing cover is disposed on one side of the band-held electronic device opposite a panel, the touch-sensing cover comprises a cover and a touch-sensing structure having detection points, a controller is connected to the touch-sensing structure, a memory stores an initiative determination condition, and a processor is connected to the controller by signaling. In the controller, a driving unit outputs a driving signal to the touch-sensing structure, a sensing unit receives a trigger signal of a trigger event from the touch-sensing structure, and a processing unit receives the trigger signal and computes the detection points of the trigger event to generate a computed result and compares the computed result with the initiative determination condition. The processor executes an action for the hand-held electronic device if the trigger event conforms to the initiative determination condition.

### CROSS REFERENCE TO RELATED APPLICATIONS

This Non-provisional application claims priority under 35 U.S.C. §119(a) on Patent Application No(s). 201410360046.4, 201410360029.0, 201410361716.4 and 201410361549.3 filed in People's Republic of China on Jul. 25, 2014, the entire contents of which are hereby incorporated by reference.

### BACKGROUND OF THE INVENTION

1. Field of Invention

The invention relates to a controller, in particular to a controller applied to a shadeless touch hand-held electronic device.

2. Related Art

With the progress of technologies, various novel digital devices are invented, such as cell phones, tablet computers, ultrabooks, or UPS (Global Positioning System) navigation device, etc. In addition to conventional input or control manners by keyboard or mouse, utilizing the touch-control technique to operate the digital device is a straight and popular operative manner. The touch display device has a friendly and intuitive input operation interface, and therefore users of all ages can manipulate the touch display device by fingers or a stylus.

As to the common and conventional hand-held electronic device with the touch function, the touch operations are all directly executed on the display panel. However, for the operation on the panel, fingers will shade the user's view or the software item displayed on the display panel, such that the user may erroneously touch and open an undesired link arranged in a high information content density on the display panel by user's finger. To avoid the above situation, some hand-held electronic devices adopt a design where the touch operation zone is separated from the display panel, such as disclosed by the U.S. Pat. No. 5,825,352 (Logitech).

However, such design will increase the volume of the electronic device and go against the tendency of the hand-held electronic device towards lightness, thinness and compactness, so as not to be easily carried out in the small-sized product such as tablet computer and cell phone. Moreover, the technique disclosed by the U.S. Pat. No. 5,825,352 (Logitech) also can't solve the problem of that user's view is easily shaded by user's finger in the operation of the hand-held electronic device caused by the finger.

In addition, because a user needs to contact the touch panel with fingers or stylus to control or operate the electronic device, it often scratches the panel. Besides, when operating well-known hand-held electronic device with touch control function, it usually requires one hand to hold the hand-held electronic device and the other hand to execute operation on the panel. If using just one hand to hold and operate the device, only the user's thumb can manipulate the device and thus efficiency, accuracy and convenience of manual operation are reduced.

Therefore, a controller for a shadeless touch hand-held electronic device is provided to prevent the user's view from being shaded by fingers during operating the hand-held electronic device by the user, reduce the scratch problem, and suitable to be operated by one hand.

### SUMMARY OF THE INVENTION

An aspect of the invention is to provide a controller for a shadeless touch hand-held electronic device, which can prevent the user's view from being shaded by fingers during operating the hand-held electronic device by the user, reduce the scratch problem, and is suitable to be operated by one hand.

A controller is applied to a shadeless touch hand-held electronic device which comprises a touch-sensing cover, a panel, the controller, a processor and a memory. The touch-sensing cover is disposed on one side of the hand-held electronic device opposite the panel, the touch-sensing cover comprises a cover and a touch-sensing structure, the touch-sensing structure comprises a plurality of detection points, the controller is connected to the touch-sensing structure, the memory stores an initiative determination condition, and the processor is connected to the controller by signaling. The controller comprises a driving unit, a sensing unit and a processing unit. The driving unit outputs a driving signal to the touch-sensing structure. The sensing unit receives a trigger signal of a trigger event from the touch-sensing structure. The processing unit receives the trigger signal and computes the detection points of the trigger event to generate a computed result, and compares the computed result with the initiative determination condition. The processor executes an action for the hand-held electronic device if the trigger event conforms to the initiative determination condition.

In one embodiment, the user uses the hand-held electronic device by one hand, and the touch-sensing cover faces a light source or the panel's back faces the light source.

In one embodiment, the area of the touch-sensing structure and the area of the panel have a ratio relationship, and the controller converts an input position of the touch-sensing structure into a display position of the panel according to the ratio relationship.

In one embodiment, the touch-sensing cover further comprises a wireless communication unit, the wireless communication unit comprises a wireless communication chip and an antenna, the wireless communication chip is electrically connected to the controller, and the antenna is disposed on the cover or the touch-sensing structure.

In one embodiment, the action comprises a multi-touch control, a volume control, a control for capturing images, taking pictures or recording, an unlock control, a control for turning on or turning off, a control for answering or rejecting phone call, a control for opening or closing application program, or a control for displaying content performed on the hand-held electronic device.

In one embodiment,the control for displaying content comprises a cursor moving, a screen rotation, a screen scrolling, a screen zooming, or a screen rebounding.

In one embodiment, the controller is disposed on a circuit board.

In one embodiment, the touch-sensing structure is capable of a wireless power transmission.

In one embodiment, the touch-sensing structure comprises metal mesh, metal nanowires, transparent conducting film, carbon nanotube or graphene.

In one embodiment, the controller further comprises a palmprint recognition unit receiving a palmprint. The processing unit compares the palmprint with a predefined palmprint pattern stored in the memory. The processor converts the hand-held electronic device into a unlock state of user interface if the trigger event conforms to the initiative determination condition and the palmprint corresponds to the predefined palmprint pattern.

A controller is applied to a shadeless touch hand-held electronic device which comprises a touch-sensing cover, a panel, the controller and a memory. The touch-sensing cover is disposed on one side of the hand-held electronic device opposite the panel, the touch-sensing cover comprises a cover and a touch-sensing structure, the touch-sensing structure comprises a plurality of detection points, the controller is connected to touch-sensing structure, and the memory stores an initiative determination condition. The controller comprises a driving unit and a sensing unit. The driving unit outputs a driving signal to the touch-sensing structure. The sensing unit receives a trigger signal of a trigger event from the touch-sensing structure. The controller computes the detection points of the trigger event to generate a computed result according to the trigger signal, and compares the computed result with the initiative determination condition. The controller executes an action for the hand-held electronic device if the trigger event conforms to the initiative determination condition.

In one embodiment, when the user uses the hand-held electronic device by one hand, the touch-sensing cover faces a light source or the panel's back faces the light source.

In one embodiment, the area of the touch-sensing structure and the area of the panel have a ratio relationship, the controller converts an input position of the touch-sensing structure into a display position of the panel according to the ration relationship.

In one embodiment, the touch-sensing cover further comprises a wireless communication unit, the wireless communication unit comprises a wireless communication integrated circuit and an antenna, the wireless communication integrated circuit is electrically connected to the controller, and the antenna is disposed on the cover or the touch-sensing structure.

In one embodiment, the action comprises a multi-touch control, a volume control, a control for capturing images, taking pictures or recording, an unlock control, a control for turning on or turning off, a control for answering or rejecting phone call, a control for opening or closing application program, or a control for displaying content performed on the hand-held electronic device.

In one embodiment, the control for displaying content comprises a cursor moving, a screen rotation, a screen scrolling, a screen zooming, or a screen rebounding.

In one embodiment, the controller is disposed on a circuit board.

In one embodiment, the touch-sensing structure is capable of a wireless power transmission.

In one embodiment, the touch-sensing structure comprises metal mesh, metal nanowires, transparent conducting film, carbon nanotube or graphene.

In one embodiment, the controller further comprises a palmprint recognition unit receiving a palmprint. The processing unit compares the palmprint with a predefined palmprint pattern stored in the memory. The processor converts the hand-held electronic device into a unlock state of user interface if the trigger event conforms to the initiative determination condition and the palmprint corresponds to the predefined palmprint pattern.

As mentioned above, as to the controller for the shadeless touch hand-held electronic device, the user can perform the touch operation on the touch-sensing cover of the hand-held electronic device, so the user's finger will not shade the view or the software item displayed on the panel, and the touch for opening the link of the high information density image will not erroneously execute. Besides, since operating the electronic device is performed on the touch-sensing cover, the panel scratch can be reduced. Furthermore, because the user can perform the touch operation on the touch-sensing cover, the user can use multiple fingers such as the forefinger and middle finger to operate the electronic device while using the same hand holding the device. In comparison with the conventional art where the user just can use the thumb to perform the operation while using the same hand holding the device, the disclosure can provide more manual efficiency and convenience and can realize a better user experience.

Furthermore, when the user uses the hand-held electronic device under the sunlight or the strong light source, he can hold the hand-held electronic device just by one hand and use the touch-sensing cover to block the sunlight or the strong light source. Due to the panel information resulting from the touch-sensing cover which blocks the sunlight or the strong light source, the sunlight visibility of the panel is improved, and it can be implemented without advanced display panel technique (for example OLED display panel or electric paper display panel).

Besides, in the hand-held electronic device, the trigger quantity, the trigger quantity distribution, the trigger morphology, the trigger time, the trigger frequency or the trigger location must firstly conform to the initiative determination condition, then the controller is permitted to perform various control on the hand-held electronic device (for example a multi-touch control, a volume control, a control for capturing images, taking pictures or recording, an unlock control, a control for turning on or turning off, a control for answering or rejecting phone call, a control for opening or closing application program, or a control for displaying content, etc.). Therefore, when other user uses the hand-held electronic device, because the trigger quantity, the trigger quantity distribution, the trigger morphology, the trigger time, the trigger frequency or the trigger location is distinct from the initiative determination condition which is predefined by the origin user, the hand-held electronic device is forbidden to operate so as to enhance the security of the hand-held electronic device.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a hand-held electronic device for a controller according to the embodiment of the invention;

FIG. 2 is a block diagram of the hand-held electronic device and the controller of FIG l;

FIG. 3 is a schematic diagram showing the and-held electronic device of FIG. 1 at another viewing angle;

FIG. 4 is a flow chart showing the steps executed by the controller according to the embodiment;

FIG. 5 is a schematic diagram showing the detection points of the touch-sensing cover are triggered;

FIG. 6A and FIG. 6B are another schematic diagrams showing the detection points of the touch-sensing cover are triggered;

FIGS. 7A-7D are schematic diagrams showing the input action by the user on the hand-held electronic device;

FIG. 8A is a schematic diagram showing a lock state of user interface of the hand-held electronic device of FIG. 1;

FIG. 8B is a block diagram of the hand-held electronic device of FIG. 1 according to another embodiment;

FIG. 8C is a schematic diagram showing another operation state of the hand-held electronic device of FIG. 8B;

FIGS. 9A-9G are schematic diagrams showing various user interfaces of the hand-held electronic device of FIG. 1;

FIG. 10A is a block diagram of the hand-held electronic device of FIG. 1 according to another embodiment; and

FIG. 10B is a block diagram of the hand-held electronic device of FIG. 1 according to another embodiment.

### DETAILED DESCRIPTION OF THE INVENTION

A controller of the present invention will be apparent from the following detailed description, which proceeds with reference to the accompanying drawings, wherein the same references relate to the same elements.

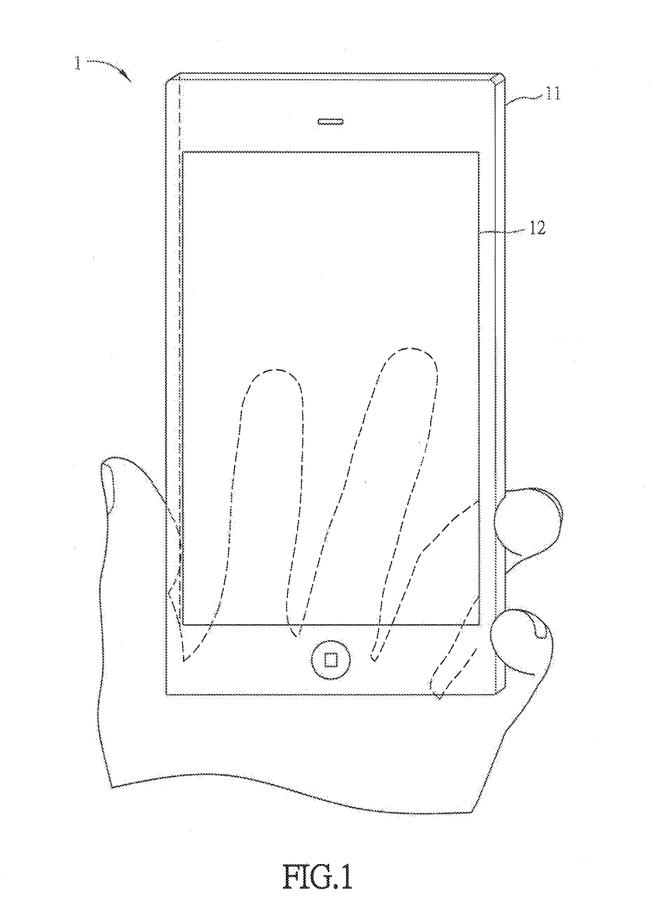

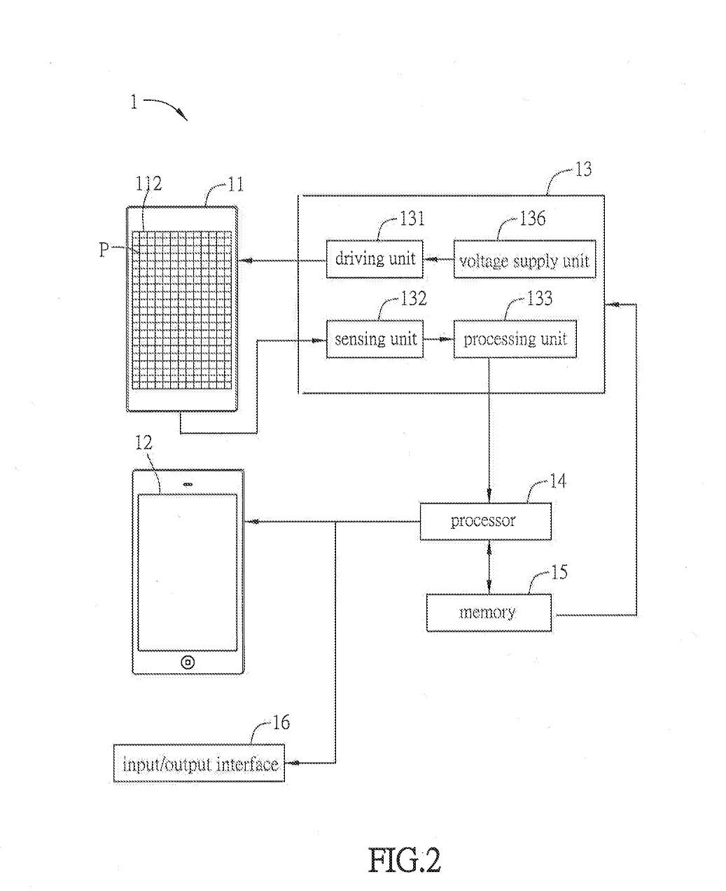

FIG. 1 is a schematic diagram showing a hand-held electronic device for a controller according to the embodiment of the invention. FIG. 2 is a block diagram showing the hand-held electronic device and the controller of FIG. 1. Referring to FIGS. 1-2, the shadeless touch hand-held electronic device 1 (hereinafter abbreviated to hand-held electronic device 1) comprises a touch-sensing cover 11, a panel 12, a controller 13, a processor 14 and a memory 15. The hand-held electronic device 1 can be a smart phone, a tablet computer, a personal digital assistant (PDA) or a global positioning system (GPS) device. In the embodiment, the hand-held smart phone is taken as an example. The panel 12 can comprise a display panel namely a panel having display function or a touch display panel having display function and touch function.

In the embodiment, the touch-sensing cover 11 is disposed on one side of the hand-held electronic device 1 opposite to the panel 12. In other words, the touch-sensing cover 11 and the panel 12 are respectively disposed on the two opposite sides of the hand-held electronic device 1, namely, disposed on the front side and the back side of the hand-held electronic device 1. When the user uses the hand-held electronic device 1, the side facing the user is the front side and the side against the user is the back side.

In details, the touch-sensing cover 11 of the embodiment provides the interface between the electronic device and the user. For example, the panel 12 can display a user interface (UI) or a graphical user interface (GUI). Therefore, as shown in FIG. 1, the user can view the content displayed on the panel 12 in the front side of the hand-held electronic device 1 and execute the input operation on the touch-sensing cover 11 in the back side.

In addition, when the user use the hand-held electronic device 1 under the sunlight or in the strong light source, the user can operate the hand-held electronic device 1 by one hand and utilize the touch-sensing cover 11 to face the sunlight or the strong light source for blocking the sunlight or the strong light source. Because the back of the panel 12 faces the sunlight or the strong light source, the sunlight visibility of the panel 12 can be enhanced resulting from blocking the sunlight by the touch-sensing cover 11.

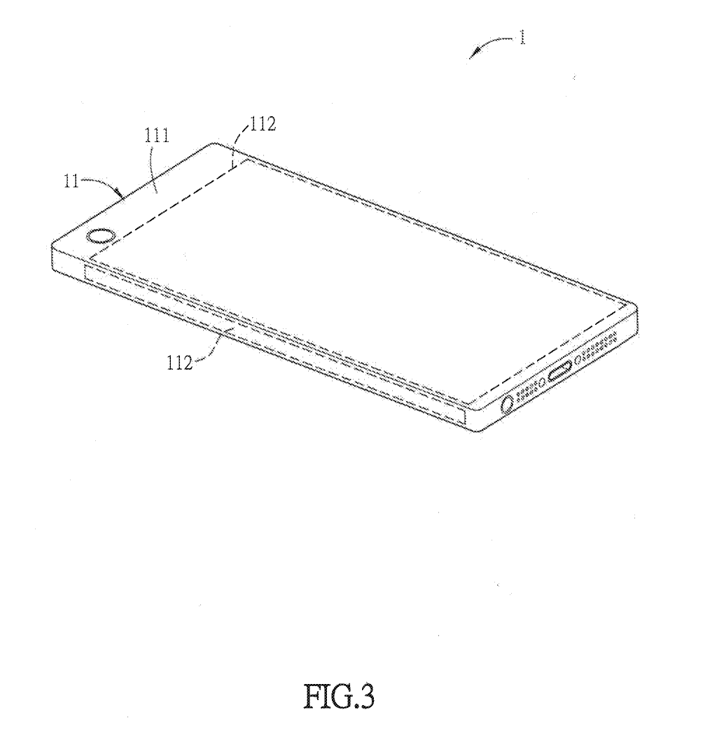

FIG. 3 is a schematic diagram showing the hand-held electronic device of FIG. 1 at another viewing angle. Referring to FIG. 2, in the embodiment, the touch-sensing cover 11 comprises a cover 111 and a touch-sensing structure 112. Similarly, the cover 111 is disposed on the side of the hand-held electronic device 1 opposite the panel 12. Partial or total area of the touch-sensing structure 112 can be disposed on the cover 111. In the embodiment, the touch-sensing structure 112 extends to the two side of the cover 111, namely, extends to the two side edges of the touch-sensing cover 11 so as to increase the operation area for the user. In the embodiment, the area of the touch-sensing structure 112 is larger than the area of the panel 12. In the other embodiment, other physical keys can be replaced by the touch-sensing structure 112 of the embodiment, which is not limited thereto.

In some embodiments, for more effectively using the width of the cover 111 for disposing the touch-sensing structure 112, the width of the touch-sensing structure 112 can be slightly less than that of the cover 131 (e.g. about 5%˜10%), namely, the width of the touch-sensing structure 112 is about 90%˜95% of the width of the cover 111. The touch-sensing structure 112 can also yield to the position of the camera lens or the flash of the cover 111, for example, there is no touch-sensing structure 112 allocated at a local region of the touch-sensing cover 111 (namely the position of the camera lens or the flash).

In some embodiments, the area of touch-sensing structure 112 can be equal to the area of the panel 12.

In the embodiment, the touch-sensing structure 112 can be, for example, a capacitive touch-sensing structure, and the touch-sensing structure 112 is formed on an inner surface of the cover 111 facing the panel 12, namely, the touch-sensing structure 112 is disposed inside the hand-held electronic device 1 and formed with total area on the cover 111. In other embodiments, the touch-sensing structure 112 can also be formed on the outer surface of the cover 111 away from the panel 12, namely, the touch-sensing structure 112 is disposed outside the hand-held electronic device 1. If the touch-sensing structure 112 is disposed on the outer surface of the cover 111 away from the panel 12, a protection layer could be added to protect the touch-sensing structure 112. The touch-sensing structure 112 can be simultaneously formed on the inner surface of the cover 111 facing the panel 12 and the outer surface of the cover 111 away from the panel 12, namely, the touch-sensing structure 112 is simultaneously disposed inside and outside the hand-held electronic device 1. In addition, the material of the cover 111 can comprises glass, plastic, metal or other material, and the cover 111 is a part of the whole structure of the hand-held electronic device 1. In other words, the touch-sensing cover 11 is not an additional component (such as the protection cover of the electronic device), so if the touch-sensing cover 11 is separated from the hand-held electronic device 1, the inside components of the hand-held electronic device 1, such as battery or integrated circuit can be seen.

Furthermore, the touch-sensing structure 112 can be single-layer or double-layer, and the touch-sensing structure is capable of a wireless power transmission.

In the embodiment, the touch-sensing structure 112 is double-layer for example. The touch-sensing structure 112 can comprise a first sensing layer separately disposed along a first direction (X direction), and a second sensing layer separately disposed along a second direction (Y direction).

Additionally, the touch-sensing structure 112 can comprise metal mesh, metal nanowires, transparent conducting film, carbon nanotube or graphene which is not limited thereto. In some embodiments, if the touch-sensing structure 112 is the metal-mesh, the Moire phenomenon and material cost can be reduced, and the line width will not be limited due to the transparency requirement.

If the touch-sensing structure 112 is made by metal mesh, the metal texture effect can be exhibited on the appearance when the touch-sensing structure 112 is disposed on the outer surface (not the display surface) of the cover 111. Accordingly for example, the cover of metal texture is implemented by disposing the touch-sensing structure 112 composed of the metal mesh on the outer surface (not the display surface) of the cover 111 made by non-metal material. Thus, the metal-made cover (requiring a more complicated process) is unnecessary to be used, so as to further achieve cost saving.

In addition, the area of the touch-sensing structure 112 and the area of the panel 12 have a ration relationship. The controller 13 can utilize the ratio relationship to convert the touch points on the touch-sensing cover 11 into the corresponding positions of the panel 12. When the user, for example, uses fingers execute the touch operation on the touch-sensing cover 11, the panel 12 can display the corresponding action according to the user's operation gesture (or called the hand gesture). The controller 13 will convert the input positions of the touch-sensing structure 112 into the display positions of the panel 12, and the panel 12 will show a visible sign at the display position.

In the embodiment, the controller 13 can be disposed on a circuit board, and the circuit board can be disposed between the touch-sensing cover 11 and the panel 12. In other embodiments, the controller 13 and the processor 14 can be integrated into the same circuit board to from a control-process center in the chip. Besides, the wiring connecting to the touch-sensing structure 112 can be gathered to a single side for the wiring outlet and then electrically connected to a circuit board, so as to enhance the design flexibility. Additionally, a battery can be further disposed between the touch-sensing cover 11 and the panel 12 for providing the power of the hand-held electronic device 1.

The memory 15 of the embodiment can be disposed between the touch-sensing cover 11 and the panel 12. Similarly, the memory 15 can also be integrated with the controller 13 and the processor 14 into the same circuit board. The memory 15 can be, for example but not limited to, a read-only memory (ROM), a random access memory (RAM), a flash memory, a field-programmable gate array (FPGA), or other memory. The memory 15 can store an operation system, an application program, a data processing program, electronic data of various document or other programs. The operation system is the program managing the computer hardware and software resources. The application program can be a text edit program, email program, etc. The data processing program is a program which detects the data structure of electronic data and generates linking instructions correspondingly.

In addition, as shown in FIG. 2, the touch-sensing structure 112 has a plurality of detection points P and the detection points P can be triggered to trigger a trigger event. For example, when a conductor (it can be for example but not limited to a stylus, user's finger or hand, etc.) contacts the touch-sensing structure 112, the detection points P located at the contact position can be triggered to generate a trigger signal corresponding to the trigger event. The trigger signal will be transmitted to the controller 13 which processes for the trigger event. The details will be explained in the following description. Here, the trigger event can be generated corresponding to a holding position by the user when he holds the touch-sensing cover 11 by hand, or it is generated when the user perform an input action on the touch-sensing cover 11, but it is not limited thereto.

Accordingly, the touch-sensing cover 11 and the panel 12 are respectively disposed on the two opposite sides of the hand-held electronic device 1. It prevents user's hand from shading the display screen when the user uses the hand-held electronic device 1 for achieving shadeless touch, and it further avoids the erroneous touch operation. Additionally, the hand-held electronic device 1 in the embodiment is suitable for multi-touch by one hand.

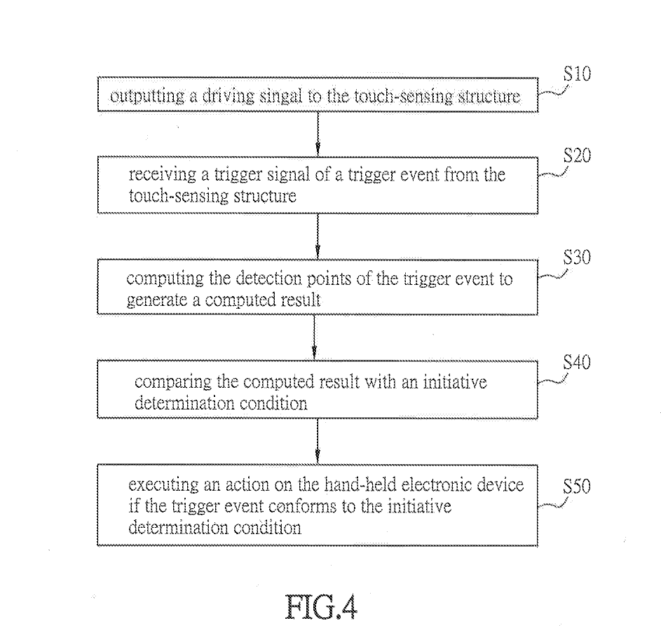

FIG. 4 is a flow chart showing the steps executed by the controller according to the embodiment. The steps comprise the following steps: outputting a driving signal to the touch-sensing structure (Step S10); receiving a trigger signal of a trigger event from the touch-sensing structure (Step S20); computing the detection points of the trigger event to generate a computed result (Step S30); comparing the computed result with an initiative determination condition (Step S40); and executing an operation on the hand-held electronic device if the trigger event conforms to the initiative determination condition (Step S50).

Referring to FIG. 2 and FIG. 4, in the embodiment, the controller 13 comprises a driving unit 131 and a sensing unit 132. The driving unit 131 outputs a driving signal to the touch-sensing structure 112. In some embodiments, the controller 13 can also comprise a voltage supply unit 136 which can imply to a power source. The voltage supply unit 136 supplies a voltage signal to the driving unit 131. The sensing unit 132 is connected to the touch-sensing structure 112 by signaling and receives the trigger signal from the touch-sensing structure 112. Then, the controller 13 computes the detection points P of the trigger event according to the trigger signal, and compares the computed result with an initiative determination condition pre-stored in the memory 15. If the trigger event conforms to the initiative determination condition, the sensing unit 132 permits an input action from the touch-sensing structure 112, and the controller 13 outputs an operation signal according to the input action.

Furthermore, the controller 13 can further comprise a processing unit 133. The processing unit 133 receives the trigger signal from the sensing unit 132 and computes the trigger event corresponding to the trigger signal, namely, the processing unit 133 computes the triggered detection points to generate a computed result. In some embodiments, the processing unit 133 can comprises a coordinate calculating unit for calculating the coordinates of the triggered detection points to obtain a trigger position of the trigger event, which is not limited thereto. The processing unit 133 can compute, for example, a trigger quantity, a trigger quantity distribution, a trigger morphology (which can refer to a trigger appearance), a trigger time, a trigger frequency or a trigger location (which can refer to a trigger position) of the trigger event. Then, the processing unit 133 compares the computed result with the initiative determination condition pre-stored in the memory 15, and the details of the initiative determination condition will be explained in the following description.

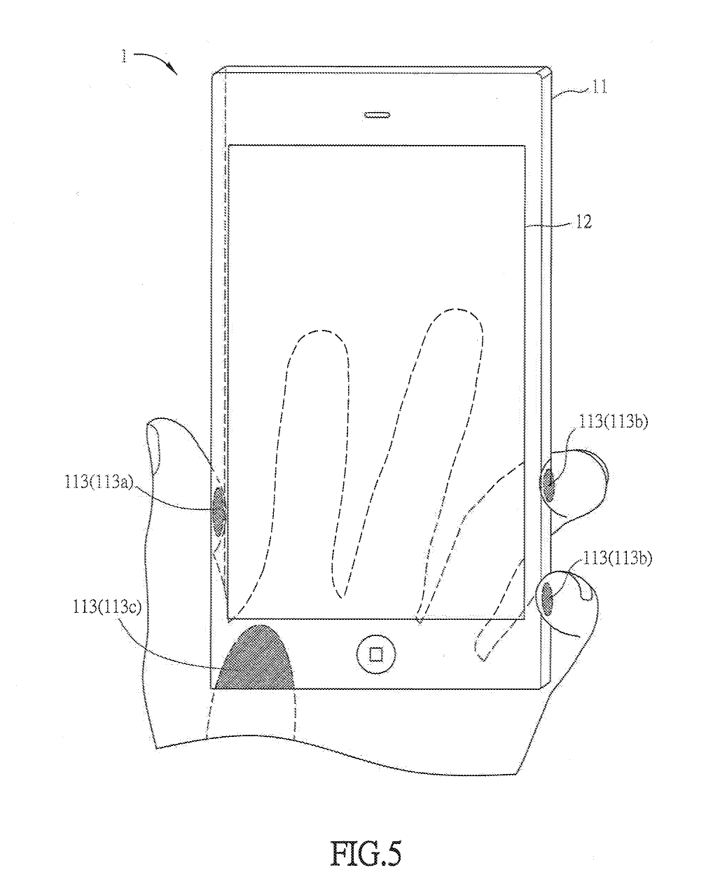

Referring to FIG. 2 and FIG. 5, FIG. 5 is a schematic diagram showing the detection points of the touch-sensing cover are triggered. In details, when the user uses the hand-held electronic device 1, the user can preset the holding habits when operating the setting interface, accordingly, the control unit 13 can analyze the trigger event of the detection point triggered by the user when operating the setting interface. The trigger event can be defined as the initiative determination condition and stored in the memory 15. The trigger event comprises the trigger quantity, the trigger quantity distribution, the trigger morphology, the trigger time, the trigger frequency or the trigger location. Taking the trigger quantity distribution, the trigger morphology or the trigger position of the trigger event as examples, when the user holds the hand-held electronic device 1, the sensing unit 132 receives the trigger signal generated by user's holding. Then, the processing unit 133 computes for example the positions of the triggered detection points according to the trigger signals, and defines the region where the number of the adjacent triggered detection points P is larger than a predetermined value as a trigger zone 113. Taking FIG. 5 as an example, a sidewall of the touch-sensing cover 11 has a trigger zone 113a and another sidewall has two trigger zones 113b. The side of the touch-sensing cover 11 opposite the panel 12 has a trigger zone 113c. In the embodiment, the “trigger quantity distribution” and the “trigger position” respectively indicate the quantity distribution and the position of each trigger zone 113, and the trigger morphology indicates the shape of each trigger zone 113, namely, the shapes of the trigger zones 113a, 113b, 113c. Moreover, the trigger frequency indicates the click frequency at a certain position, and the trigger time indicates that the holding time exceeds a certain time or is related to the user's personal habit.

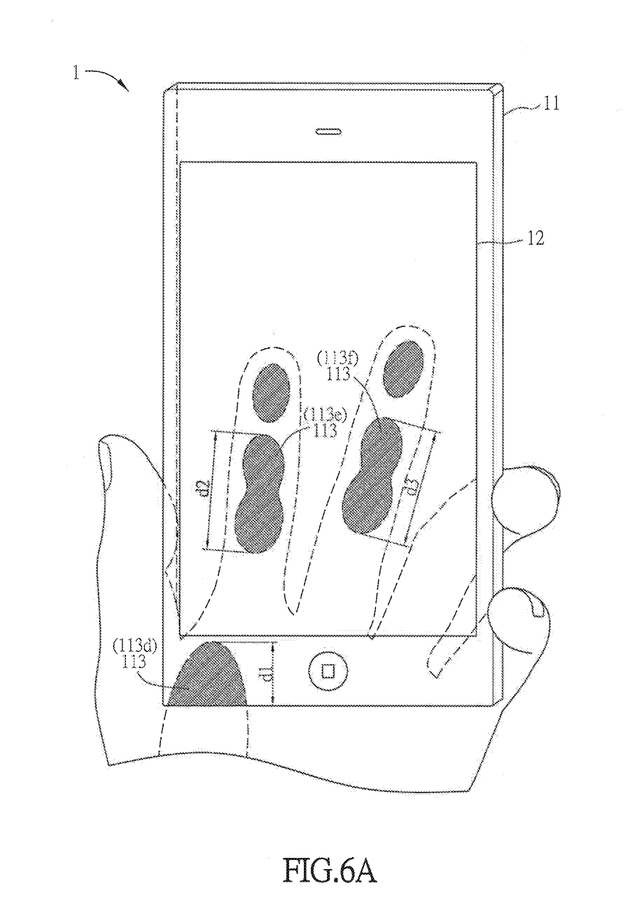

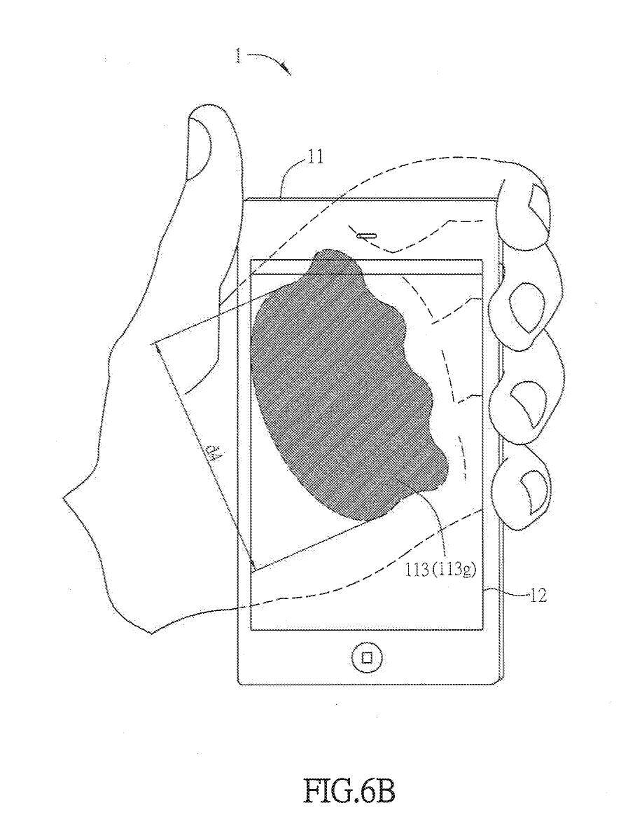

FIG. 6A and FIG. 6B are another schematic diagrams showing the detection points of the touch-sensing cover are triggered. Referring to FIG. 6A, it is noted that if the computed result of the processing unit 133 (as shown in FIG. 2) indicates multiple area contacts, the processing unit 133 (as shown in FIG. 2) will directly determine the trigger event not to conform to the initiative determination condition. Multiple means two or more than two. In the embodiment, “area contact” means that the diameter of a single touch region on the touch-sensing cover 11 which the user contacts or the longest distance from one touch edge to the other touch edge is longer than 7 mm. Taking FIG. 6 for example, because the trigger zones 133d, 133e, 113f are not circles, therefore when longest distances d1, d2, d3 from one touch edge to the other touch edge of the trigger zones 133d, 133e, 113f or more trigger zones are longer than 7 mm, it is directly determined that the trigger event does not conform to the initiative determination condition. The above configuration is based on the condition that it is easy to generate the trigger morphology indicating multiple area contacts when the user does not perform touch operation on the hand-held electronic device 1 and he only simply holds the hand-held electronic device 1, and thus the processing unit 133 (as shown in FIG. 2) surely determines the trigger event not to conform to the initiative determination condition. Then referring to FIG. 6B, if the trigger morphology of the trigger event indicates single area contact and the position of the single area contact is located at the upper part of the hand-held electronic device 1, the processing unit 133 (as shown in FIG. 2) determines the trigger event not to conform to the initiative determination condition. The above configuration is based on the condition that when the user regularly holds the hand-held electronic device 2 and utilizes his finger to perform touch operation on the touch-sensing cover 11, the palm of the user may form a trigger zone of area contact on the lower part of the hand-held electronic device 1, and the trigger zone of area contact is not formed on the upper part. As to the touch region formed on the upper part by the touch-sensing cover 11 and the finger performing the touch operation, its diameter or the longest distance from one touch edge to the other touch edge is usually not longer than 7 mm. When there is a trigger zone 113g like FIG. 6B on the upper part of the hand-held electronic device 1 and the longest distance from its one touch edge to the other touch edge is longer than 7 mm, it is very possible that the user does not perform touch operation but for example wipes the cover 111 or merely holds the hand-held electronic device 1. Therefore, if the trigger morphology of the trigger event indicates single area contact and it is located at the upper part of the hand-held electronic device 1, it is directly determined not to conform to the initiative determination condition. Here, to distinguish between the upper part and the lower part can depend on the center of the cover 111 or the center of the touch-sensing structure 112, and it still depends on actual situation when the user uses the hand-held electronic device 1. The portion upper than the center is regarded as the upper part, and the portion lower than the center is regarded as the lower part.

As shown in FIG. 2, accordingly, when the user sets the initiative determination condition on the operation setting interface and stores it in the memory 15, the processing unit 133 can compare another trigger event with the initiative determination condition. If another trigger event occurs, the sensing unit 132 of the controller 13 receives another trigger signal of another trigger event. Similarly, the processing unit 133 computes another trigger signal to generate a computed result and compares the computed result with the initiative determination condition.

In some embodiments, if the trigger event conforms to the initiative determination condition, the controller 13 (or the processor 14) will directly execute an operation on the hand-held electronic device 1.

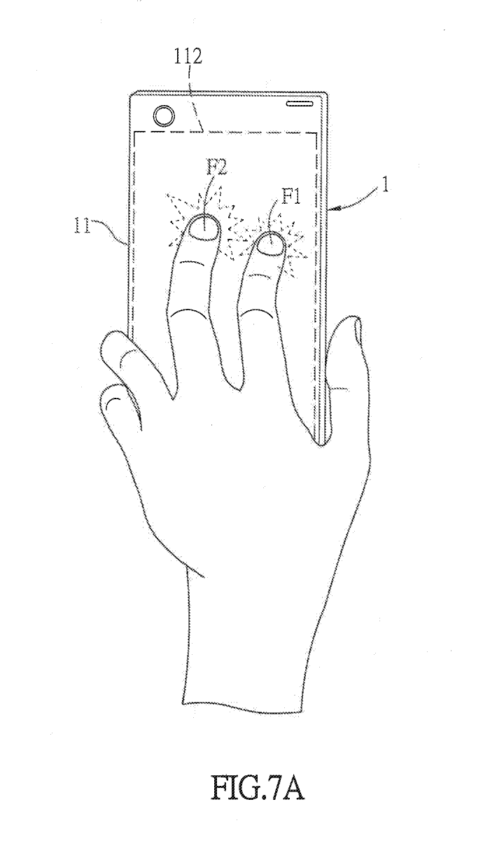

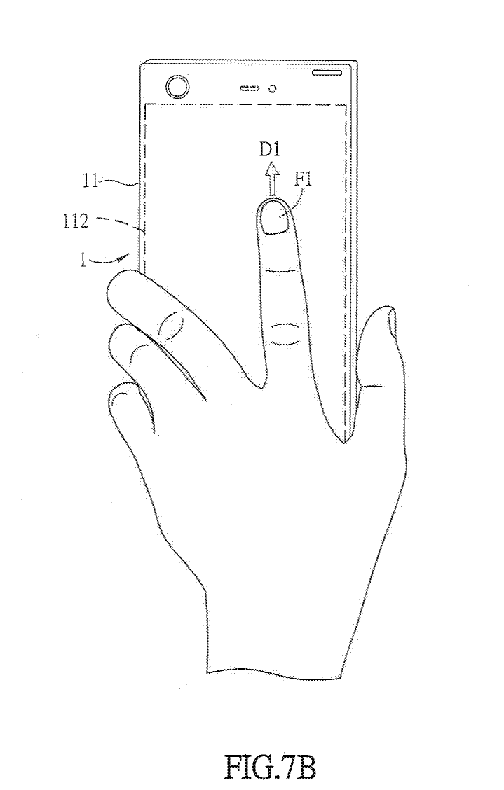

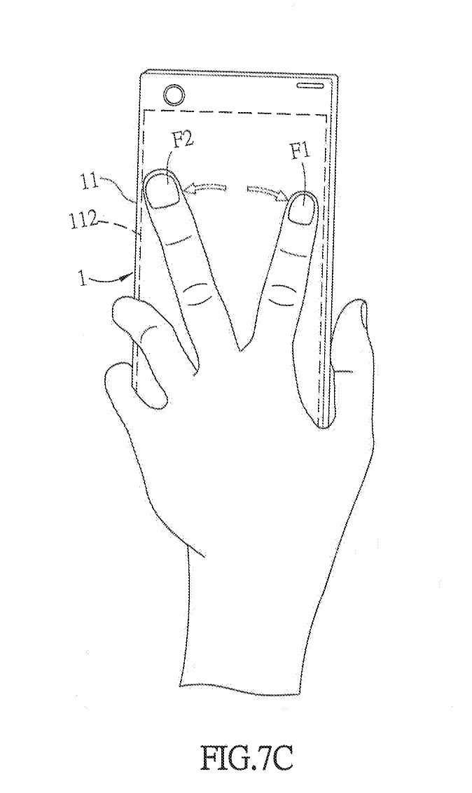

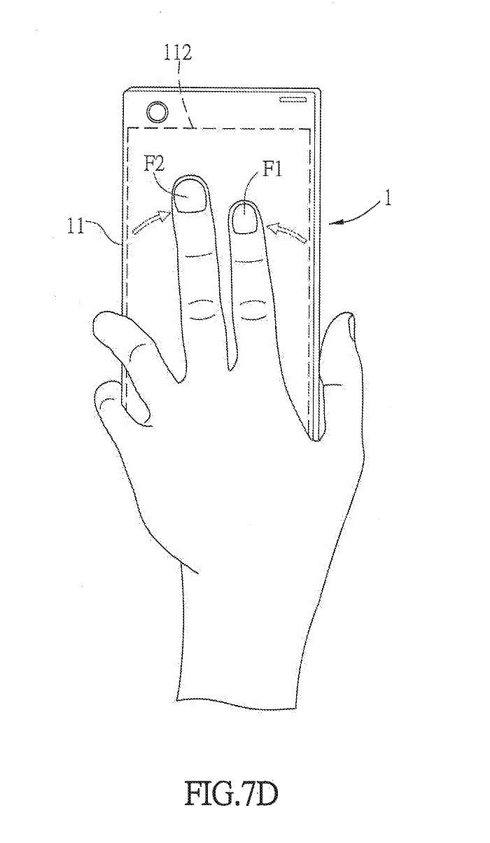

In other embodiments, if the trigger event conforms to the initiative determination condition, the sensing unit 132 is permitted to receive at least one input action from the touch-sensing structure 112. The input action is generated by the user's contact on the touch-sensing cover 11. The user's input action can comprise clicking on the touch-sensing cover 11 by fingers F1, F2 (as shown in FIG. 7A), or sliding along a specific direction by a finger F1 (as shown in FIG. 7B), or reversely sliding by fingers F1, F2 (as shown in FIG. 7C), or oppositely sliding by fingers F1, F2 (as shown in FIG. 7D). The processing unit 133 outputs an operation signal to the processor 14 according to the input action. Then, the processor 14 executes an action on the hand-held electronic device 1 according to the operation signal.

In the embodiment, the processor 14 can be a central processing unit (CPU) of the hand-held electronic device 1. In other words, in the embodiment, the trigger quantity, the trigger quantity distribution, the trigger morphology, the trigger time, the trigger frequency or the trigger location must firstly conform to the initiative determination condition, when the processor 14 executes the operation on the hand-held electronic device 1. Therefore, when other user holds and wants to use the hand-held electronic device 1, this people is not permitted to operate the hand-held electronic device 1 because the trigger quantity, the trigger quantity distribution, the trigger morphology, the trigger time, the trigger frequency, the trigger location or other trigger event is distinct from the initiative determination condition which is predefined by the origin user. Therefore, the security of the hand-held electronic device 1 can be enhanced.

The “operation” may comprise a multi-touch control, a volume control, a control for capturing images, taking pictures or recording, an unlock control, a control for turning on or turning off, a control for answering or rejecting phone call, a control for opening or closing application program, or a control for displaying content performed on the hand-held electronic device 1. The control for displaying content comprises a cursor moving, a screen rotation, a screen scrolling, a screen zooming, or a screen rebounding displayed on the panel 12.

In addition, the “operation” may be controlling the input/output interface 16 of the hand-held electronic device 1 by the processor 14. For example, the hand-held electronic device 1 can connect to an earphone by the input/output interface 16, and the processor 14 can control the volume of the earphone.

First, “control for turning on” and “control for turning off” will be described as follows. Referring to FIG. 2 and FIG. 7A, when the hand-held electronic device 1 is in a turn-on state and the user simultaneously contacts the touch-sensing cover 11 by two fingers (especially the forefinger F1 and the middle finger F2), the touch-sensing structure 112 correspondingly outputs a trigger signal and the sensing unit 132 transmits the trigger signal to the processing unit 133. Hereafter, the processing unit 133 transmits a turn-off operation signal to the processor 14. Then, the processor 14 turns off the hand-held electronic device 1 according to the turn-off operation signal. Similarly, if the hand-held electronic device 1 is initially in a turn-off state and the user simultaneously contacts the touch-sensing cover 11 by two fingers (especially the forefinger F1 and the middle finger F2), the processing unit 133 outputs a turn-on operation signal to the processor 14. Then the processor 14 turns on the hand-held electronic device 1 according to the turn-on operation signal,

Then, referring to FIG. 2 and FIG. 7C, when the hand-held electronic device 1 is in a turn-off state and the user reversely slides on the touch-sensing cover 11 (also called outwardly sliding) by two fingers (especially the forefinger F1 and the middle finger F2). Herein, the touch-sensing structure 112 correspondingly outputs a trigger signal and the sensing unit 132 transmits the trigger signal to the processing unit 133. Then, the processing unit 133 outputs a turn-on operation signal to the processor 14. The processor 14 turns on the hand-held electronic device 1 according to the turn-on operation signal.

Referring to FIG. 2 and FIG. 7D, when the hand-held electronic device 1 is in a turn-on state, and the user oppositely slides on the touch-sensing cover 11 (also called inwardly sliding) by two fingers (especially the forefinger F1 and the middle finger F2), the touch-sensing structure 112 outputs correspondingly a trigger signal and the sensing unit 132 transmits the trigger signal to the processing unit 133. Then the processing unit 133 transmits a turn-off operation signal to the processor 14. The processor 14 turns off the hand-held electronic device 1 according to the turn-off operation signal.

In addition, in some embodiments, the hand-held electronic device 1 can execute the turn-on operation according to the palm gesture of the user's holding. In other words, the above initiative determination condition can be a habitual palm gesture of user of the hand-held electronic device 1. When the computed result indicates that currently the user's palm gesture is the same with the habitual palm gesture of the initiative determination condition, the hand-held electronic device 1 is permitted to receive other input actions to execute the turn-on procedure. The input action can be the palm gesture during holding by the user instead of another holding action or input action, namely, the hand-held electronic device 1 can execute the turn-on procedure by the user's palm gesture.

As described above, the user can directly execute the turn-on operation or the turn-off operation in the same holding gesture, and it is not necessary for the user to use the conventional art that the finger is required to move to the physical key or the other hand is required to contact the touch display panel to execute the turn on/off control.

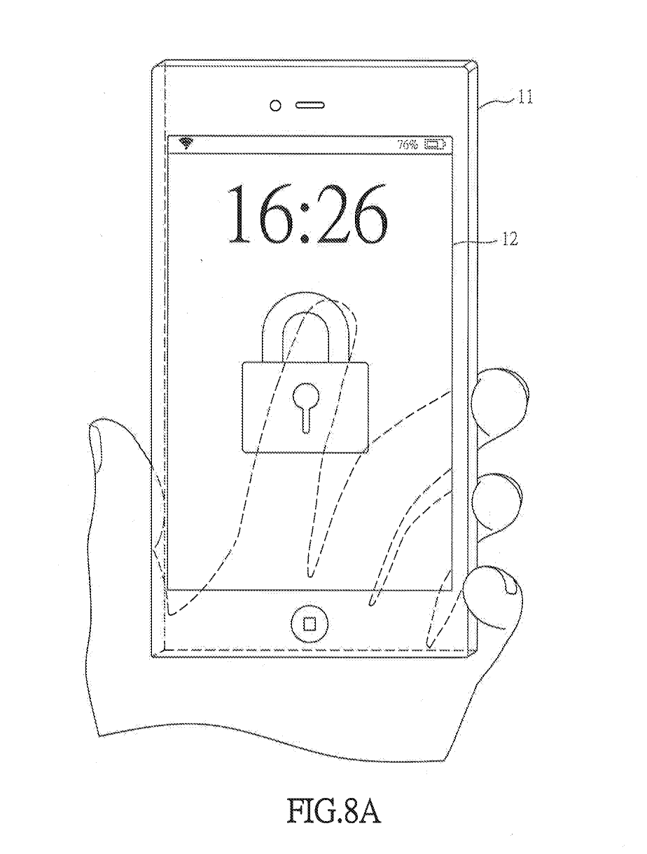

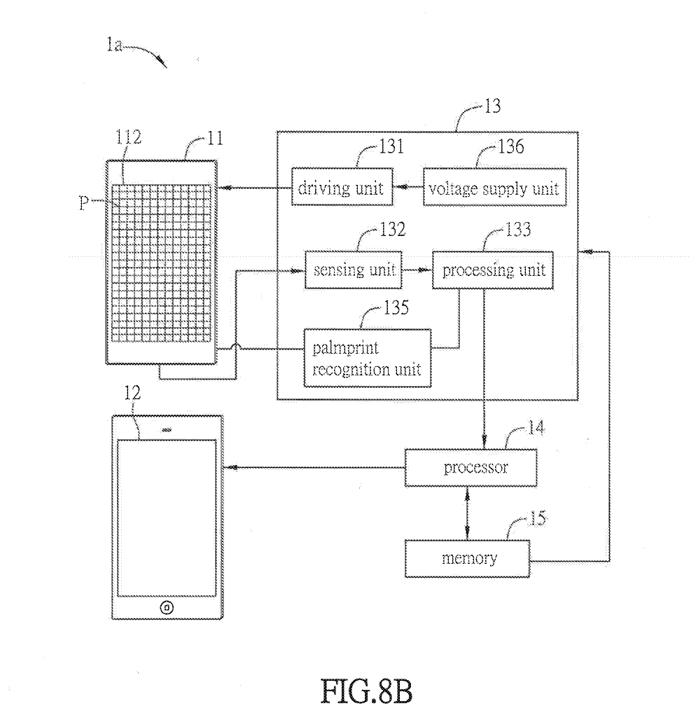

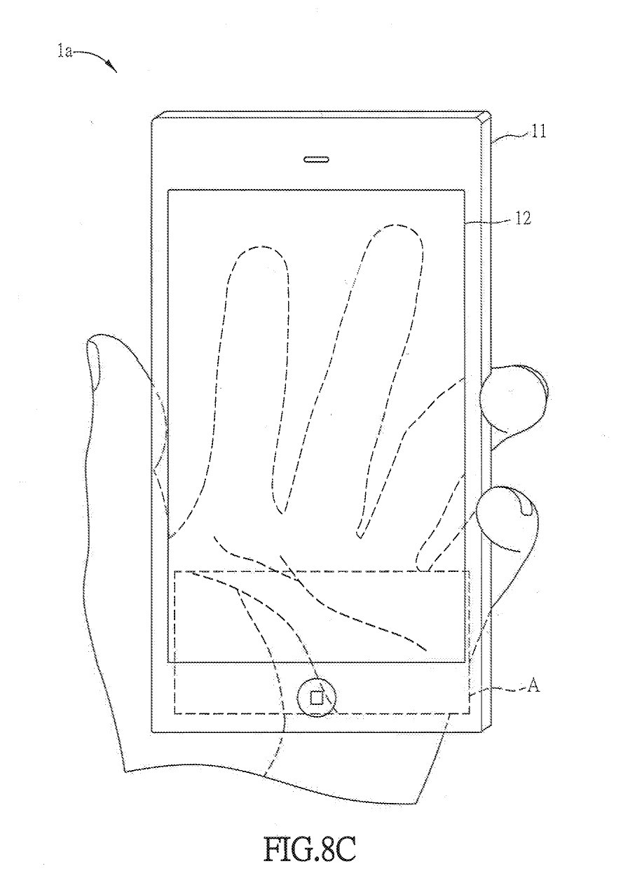

The “unlock control” will be described as follows. FIG. 8A is a schematic diagram showing a lock state of user interface of the hand-held electronic device of FIG. 1. Herein, in the “lock state of user interface” (hereafter called lock state), the hand-held electronic device 1 is still powered on and operative. However, in the lock state, the hand-held electronic device 1 only responds to some designate touch actions on the touch-sensing cover 11. As described above, if the trigger event conforms to the initiative determination condition, the hand-held electronic device 1 is converted into a unlock state of user interface (hereafter called unlock state).

When the hand-held electronic device 1 in converted into the unlock state, the hand-held electronic device 1 can display the user interface objects (e.g. icon) corresponding to one or more functions on the panel 12 and/or the information that the user may be interested in. These user interface objects are objects to constitute the user interface of the hand-held electronic device 1, for example but not limited to, which comprise a text, an image, a icon, a virtual key, a pull-down menu, an option button, a confirm box, an optional list or a dialog box. The displayed user interface objects can comprise a non-interactive object for transmitting information or constituting the user interface appearance, or an interactive object for user operation, or a combination of those.

In addition, in some embodiments, the hand-held electronic device 1 is converted from the lock state into the unlock state, the hand-held electronic device 1 can provide the visible sign, for example it displays the information box on the panel 12 showing the converting procedure is not success to notice the user that he does not successfully input a trigger event which conforms to the initiative determination condition. However, it is not limited thereto. In addition to the visible feedback, the hand-held electronic device 1 can further provide an invisible sign for indicating the rate of progress for example including audio notices (e.g. voice) or physical notices (e.g. vibration).

FIG. 8B is a block diagram of the hand-held electronic device of FIG. 1 according to another embodiment. FIG. 8C is a schematic diagram showing another operation state of the hand-held electronic device of FIG. 8B. Referring to FIGS. 8B and 8C, the hand-held electronic device 1a in the embodiment is similar to the hand-held electronic device 1, and the difference is that the hand-held electronic device 1a can further comprise a palmprint recognition unit 135. The hand-held electronic device 1a provides a double-unlock method for enhancing security and safety.

The location of the palmprint recognition unit 135, for example but not limited to, can be disposed in the area A in FIG. 8C for matching to the position where the palm contacts the touch-sensing cover 11. The palmprint recognition unit 135 is electrically connected to the processing unit 133 and recognizes at least one part of the palmprint of the user. In practice, the user can pre-store the palmprint patterns in the memory 15 as the predefined palmprint patterns, and in the unlock state, he sets the processor 14 of the hand-held electronic device 1a as “the double-unlock mode”. In the double-unlock mode, when the user wants to unlock the hand-held electronic device 1a, the user can put the palm to contact the area A of the cover 111 of the touch-sensing cover 11. The processing unit 133 can compare the palmprint in the designate area with the pre-stored palmprint pattern. If the trigger event conforms to the initiative determination condition and the palmprint corresponds to the predefined palmprint pattern, the hand-held electronic device 1a is converted into the unlock state and the user is permitted to execute next operations. If the trigger event does not conform to the initiative determination condition, the processing unit 133 determines that the user is not a permitted user, so that the hand-held electronic device 1a can not be converted into the unlock state. The above operation can be, for example, opening a web page, reading an e-mail, executing an application program, which is not limited thereto.

Because the unlock methods in the embodiment are executed on the touch-sensing cover 11 of the hand-held electronic device 1a, the finger of the user will not shade the view or the software object displayed on the panel, and the touch for opening the link of the high information density screen won't be erroneously executed. And also because the user can execute the touch operation on the touch-sensing cover 11, the user can hold the hand-held electronic device 1a by one hand and simply unlock the hand-held electronic device 1a by biometric recognition under the situation that the panel 12 is not shaded. In comparison with the conventional art where the user just can use the thumb to execute the operation while using the same hand holding the device, this disclosure can provide more manual efficiency and convenience.

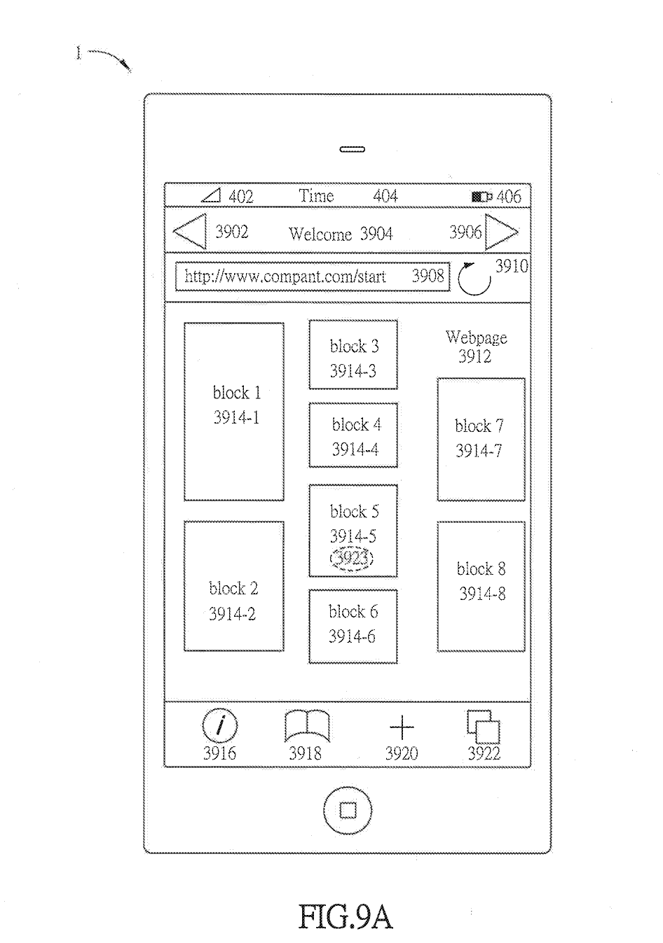

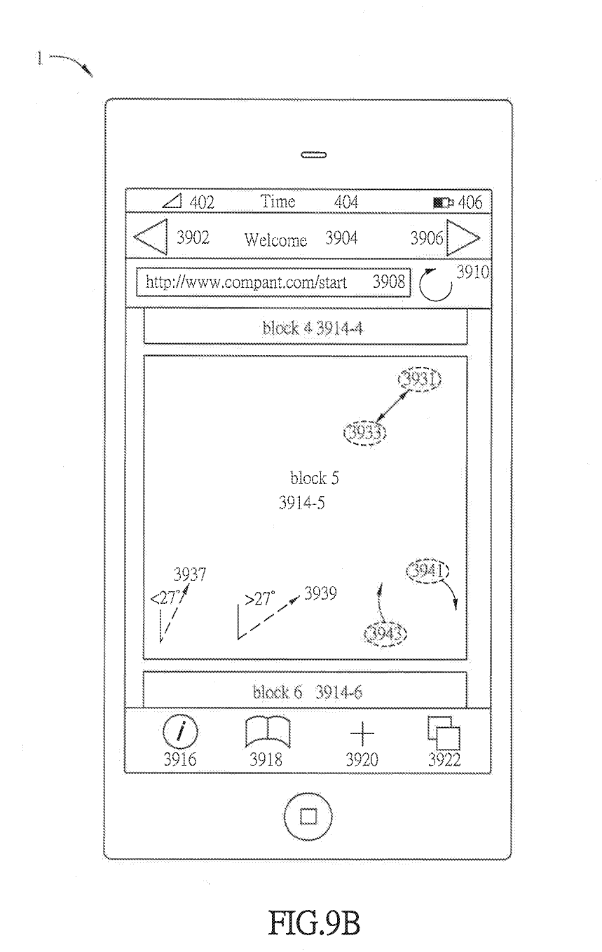

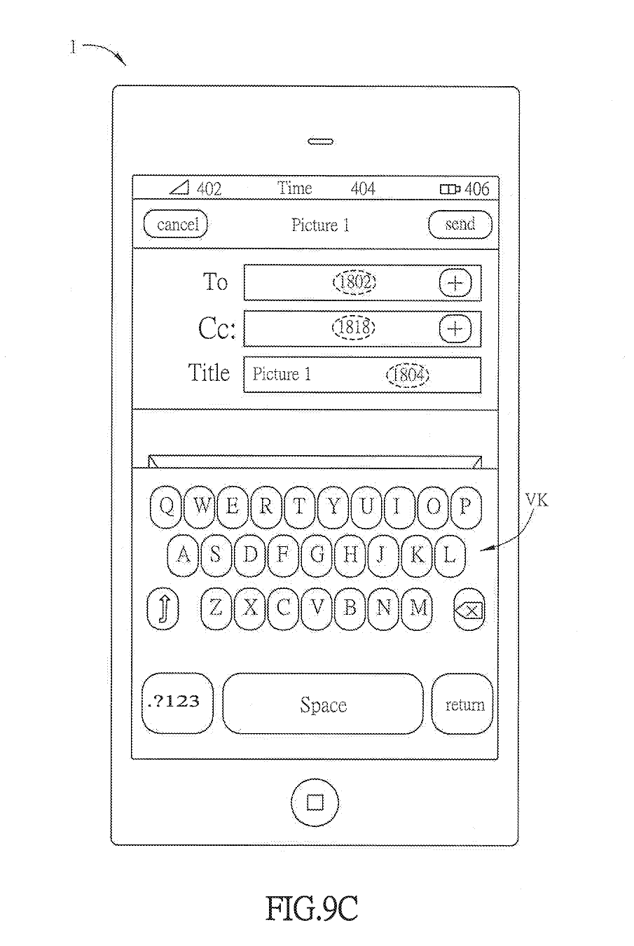

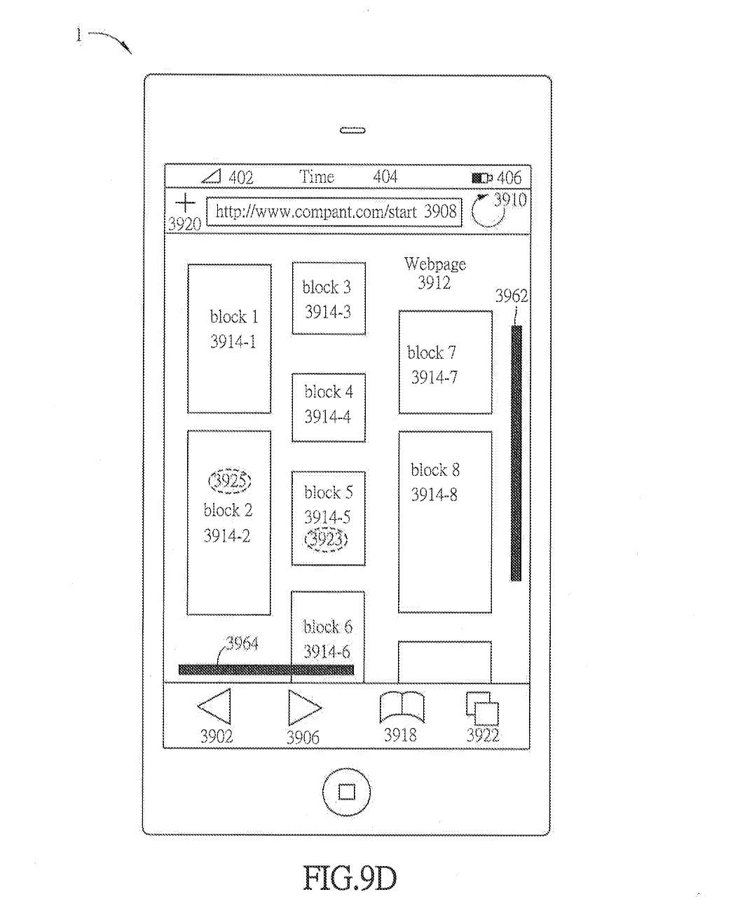

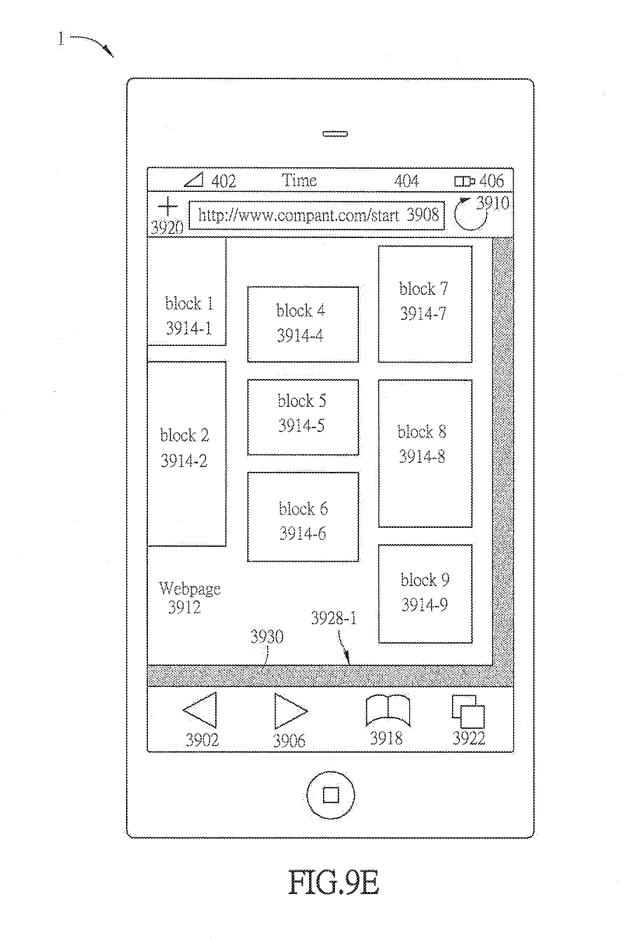

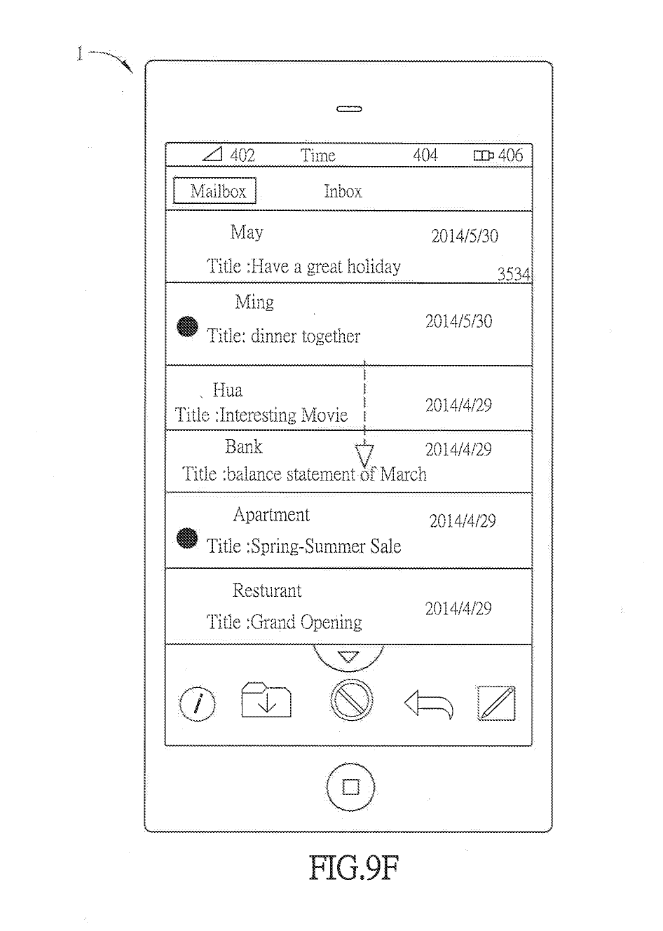

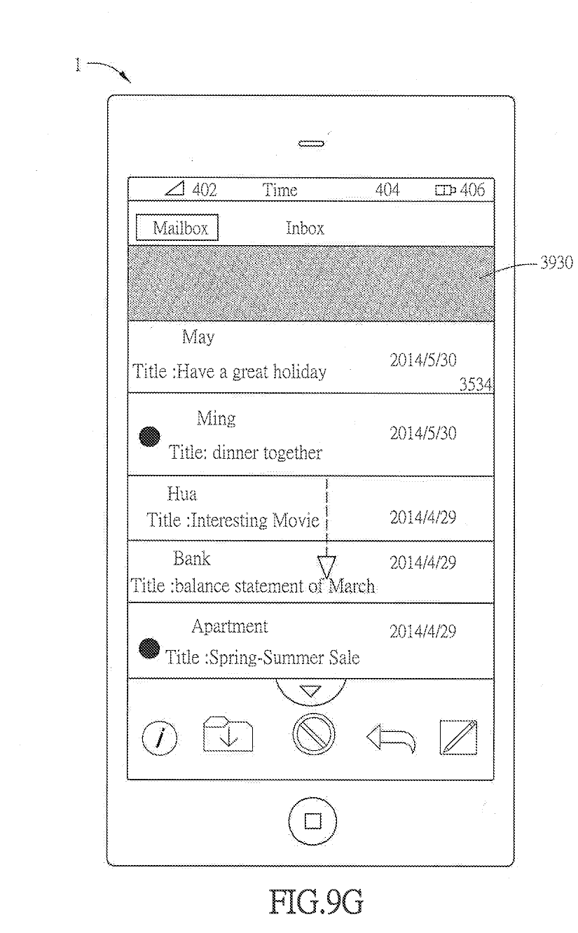

The “control for displaying content” is described as follows. From FIG. 9A to FIG. 9G are schematic diagrams showing various user interfaces of the hand-held electronic device of FIG. 1 FIG. 9A and FIG. 9B show graphical user interfaces of browser, and FIG. 9C shows a graphical user interface of e-mail. In other embodiments, the graphical user interface can be other display interface, for example, the interface of multimedia player. In addition, for simplifying drawing, the section where the user holds the hand-held electronic device 1 is not shown.

The graphical user interface displayed on the panel 12 can have one or multiple graphic, and the user can use one or multiple finger or a stylus to contact the touch-sensing cover 11 to execute the corresponding operation on the graphics displayed on the panel 12. The touch operation can comprise an operation gesture or a hand gesture, such as a single tap or multiple taps, a single slide or multiple slides (for example rightward, leftward, upward or downward slide), pinch or stretch. Moreover, the panel 12 can display an arrow or a virtual finger (not shown). When the user operates on the touch-sensing cover 13 such as moving the finger, the arrow or the virtual finger displayed on the panel 12 can move correspondingly. Thereby, the graphical user interface displayed on the panel 12 can be directly controlled by the touch-sensing cover 11, and the shadeless touch can be achieved.

In some embodiments, the graphical user interfaces can comprise, for example but be not limited to, the following elements or their subset or the hyperlink, such as (in FIG. 9A) the signal intensity indicator 402 for the wireless communication; the current time 404; the battery condition indicator 406; the previous page icon 3902, which is activated to display the previous webpage; the webpage title 3904; the next page icon 3906, which is activated to display the next webpage; the URI (uniform resource locator) input box 3908, which is used to input the URL of the webpage; the refresh icon 3910, which is activated to refresh the webpage; the webpage 3912 or another types of structured document, which is composed of the text content and other graphical blocks 3914 (displaying the text or graphical content and including the blocks 3914-1˜3914-6); the setting icon 3916, which is activated to display the setting menu of the browser; the bookmark icon 3918, which is activated to display the bookmark setting menu of the browser; the bookmark adding icon 3920, which is activated to display the graphical user interface for adding the bookmark; the new window icon 3922, which is activated to start the graphical user interface for adding a new window to the browser. In addition to the above illustrated icons, there may be other icons shown to represent other operational functions, and there may be different icons in the different graphical user interfaces, and the related illustration is omitted here for conciseness.

In some embodiments, the user can perform an input action on the touch-sensing cover 11 corresponding to the panel 12 by one finger. For example, a screen enlarging operation is executed on the panel 12 by single tap or double taps gesture. For example in FIG. 9A, the block 3914-5 is enlarged and centered (or substantially centered) on the webpage by the gesture 3923. In some embodiments, a one-click gesture or a double-click gesture by one finger is configured to enlarge the screen at a predetermined ratio, for example to enlarge to fit the entire screen.

In some embodiments, the user can perform an input action on the touch-sensing cover 11 corresponding to the panel 12 by one finger or multiple finger contact, for example a single slide or multiple slides, so that an one-dimension screen scrolling is executed on the panel 12. The one-dimension screen scrolling comprises a horizontal scrolling or a vertical scrolling. For example, in FIG. 9B, the gesture 3937 can be utilized to scroll the screen vertically, or the gesture 3939 can be utilized to scroll the screen horizontally. In addition, the vertical scrolling comprises an upward scrolling and a downward scrolling, and the horizontal scrolling comprises a leftward scrolling and a rightward scrolling. In some embodiments, the gesture for the horizontal scrolling within an angle range of 0 degree to 27 degree between the horizontal line and the sliding path can be determined as a horizontal scrolling. In some embodiments, the gesture for the vertical scrolling within an angle range of 0 degree to 27 degree between the vertical line and the sliding path can be determined as a vertical scrolling.

In some embodiments, the one-dimension scrolling can comprise a full screen scrolling or a partial screen scrolling. For example, the full screen scrolling can be defined to change the full screen when the gesture of the input action is accomplished. For example, the partial screen scrolling can be defined to divide the screen into a plurality of areas and to scroll the partial screen at one area to which the gesture of the input action correspond.

In some embodiments, for example, the partial screen scrolling can also be defined as to show a previous content before scrolling on one part of panel 12 and shows an updated content after scrolling on another part of panel 12 when the gesture of input action is accomplished. Taking upward scrolling as an example, the content shown on the panel 12 is gradually updated from bottom to top. The previous content at the upper portion is pushed out from the screen because the new content is updated and displayed on the screen from bottom to top. When a sliding speed, a sliding time or a sliding distance of the gesture of input action is within the range of a default value, the screen displayed on the panel 12 will not update totally and a part of the previous content before scrolling still remains.

In some embodiments, the user can perform an input action on the touch-sensing cover 11 corresponding to the panel 12 by multiple finger contact. For example, each of the user's fingers slides in different directions, so that a screen rotation operation for 90 degree is executed on the panel 12. For example, in FIG. 9, the screen is rotated 90 degree by the gestures 3941, 3943.

In some embodiment, the user can perform an input action on the touch-sensing cover 11 corresponding to the panel 12 by multiple finger contact. For example, a screen enlarging operation is executed on the panel 12 by stretch (sliding the user's fingers oppositely). For example, in FIG. 9B, the gestures 3931, 3933 are utilized to enlarge the screen. In some embodiments, the screen can be reduced in size by the input action from the gesture of pinch (closing fingers). In some embodiments, the controller 13 can enlarge or shrink the screen with a predetermined value according to the pinch distance or the stretch distance of the fingers.

In some embodiments, the user can perform an input action on the touch-sensing cover 11 corresponding to the text information displayed on the panel 12 by one finger or multiple fingers. For example, a virtual keyboard can be called and shown on the panel 12 by single tap or double taps. For example, in FIG. 9C, the virtual keyboard VK is called by the gesture 1802, 1818, 1804.

Finally, examples from FIG. 9D to FIG. 9G are schematic diagrams showing the screen rebounding effect of the hand-held electronic device in FIG. 1,

The steps for determining screen rebounding will be described as follows. First, the electronic data is displayed on the panel, and the electronic data will be in response to at least one input action, hereafter, the panel displays the responded electronic data. For example, if the input action of the user indicates an upward translating, the display range of the electronic data on the screen is adjusted according to the move distance of the input action.

It is determined whether the electronic data reaches the edge of the electronic data 3928-1 or not (FIG. 9E) and at least one input action is still detected. The step detects whether the electronic data reaches the bottom or the top of the item list or the text document. If the electronic data reaches the bottom or the top of the item list or the text document, detection is performed to determine whether the input action of user has stopped. If the input action of the user is still detected, the electronic data continue to be in response to at least one input action, and shows a blanking block 3930 (FIG. 9E) at the excessive area over the edge of the electronic data. The blanking block is located around the virtual boundary of the edge of the electronic data. According to various settings, the blanking block can be a black block, a grey block, a white block or a blurring background block.

It is noted that the electronic data will be translated or rolled according to at least one input action. In the embodiment, a speed of translating or rolling the electronic data to the edge of the electronic data relates to the speed of the input action.

Then, the detection continues to determine whether at least one input action exists. When the user stops inputting, for example, stops contacting (no detection point is detected) or forming a static contact point on the touch-sensing cover 11, it is determined that the user stops the input action.

If the input action on the touch-sensing cover 11 can still be detected, the blanking area 3930 and the edge of electronic data 3928-1 will be still displayed.

When the user stops the input action, the electronic data is reversely moved until the blanking block is not displayed. For example, when the user input a command to move rightward, the electronic data will be moved leftward after the user stopping inputting until the excessive area over the edge of the electronic data is not displayed.

Taking FIG. 9D and FIG. 9E as examples, the electronic data in FIG. 9D is a webpage 3912, and the size (the whole text size) of the webpage 3912 is larger than the display screen, so the user can only view a part of webpage 3912 in FIG. 9D, and the user needs to drag and translate on the touch-sensing cover 11 to view the webpage 3912. When the electronic data is translated to the end or the top, the detection of the user's input action such as dragging or translating still can be performed. In the embodiment, dragging the electronic data upward and leftward is detected. The virtual boundary of the electronic data will be displayed on the screen and a blanking block will be formed around the virtual boundary of the electronic data. When stopping the input action by the user is detected, the electronic data can rebound from the boundary of the display screen. The rebounding effect can be as fast as the speed of the user's previous input action or like an elastic ball to bounce quickly until the excessive area over the end of list is not displayed.

Similarly, taking FIG. 9F and FIG. 9G as example, the electronic data in the embodiment is items list for example such as an e-mail information list. In some embodiments, the items list also can comprise an information dialogue list, a favorite phone number list, a contact information list, a tag list, an e-mail binder list, an e-mail address list, or an address list.

In the embodiment, the item list has a first item 3534 and a last item (not shown). For example, as shown in FIG. 9F and FIG. 9G, May's e-mail is the first item 3534 at the top of the e-mail list. As to the electronic data, the list is rolled according to at least one input action when the user input a drop-down action on the touch-sensing cover 11. When the list is rolled to reach the end of e-mail list and the virtual boundary of the edge of electronic data, a blanking area 3930 is displayed. When stopping the input action by the user is detected, the list is reversely rolled. (downward) until the top area of the list is not displayed. In some embodiments, if the list is rolled to the end of list, the list will be upwardly rolled until the area over the end of list is not displayed.

A rebounding effect is accordingly generated because the electronic data is in response to the user's input action. The rebounding effect notifies the user that the displayed list or the electronic data reaches the top or bottom when the user operates the list and the electronic data. In addition, this kind of visual effect can provide the user with a more intuitive operation.

In the hand-held electronic device 1, the trigger quantity, the trigger quantity distribution, the trigger morphology, the trigger time, the trigger frequency or the trigger location must firstly conform to the initiative determination condition, then the touch-sensing cover 11 is permitted to receive at least one input action from the user correspondingly to scroll the screen in one-dimension, to rotate the screen with 90 degree, to display virtual keyboard, to enlarge the screen, to shrink the screen, to perform screen rebounding, etc. Therefore, when other user uses the hand-held electronic device 1, because the trigger event is distinct from the initiative determination condition which is predefined by the origin user, the hand-held electronic device 1 is forbidden to operate so as to enhance the security of the hand-held electronic device 1. Hence, the controller 13 can compute the trigger event of the detection points P with a determined time interval and compare it with the initiative determination condition. Thus, the security of the hand-held electronic device 1 is enhanced.

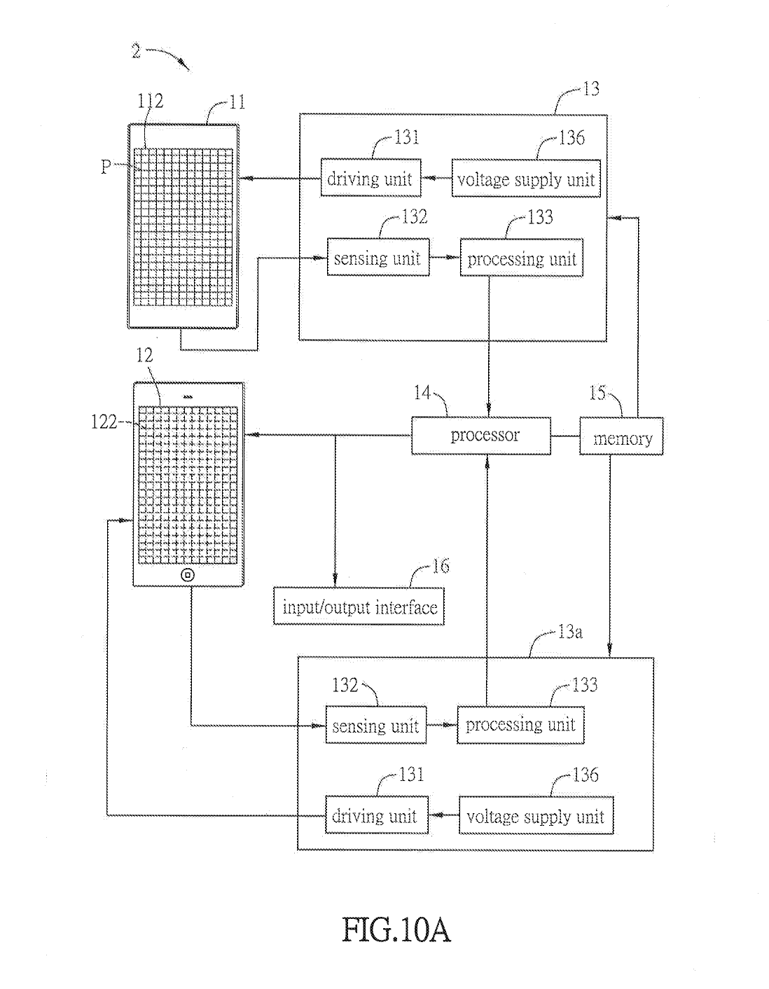

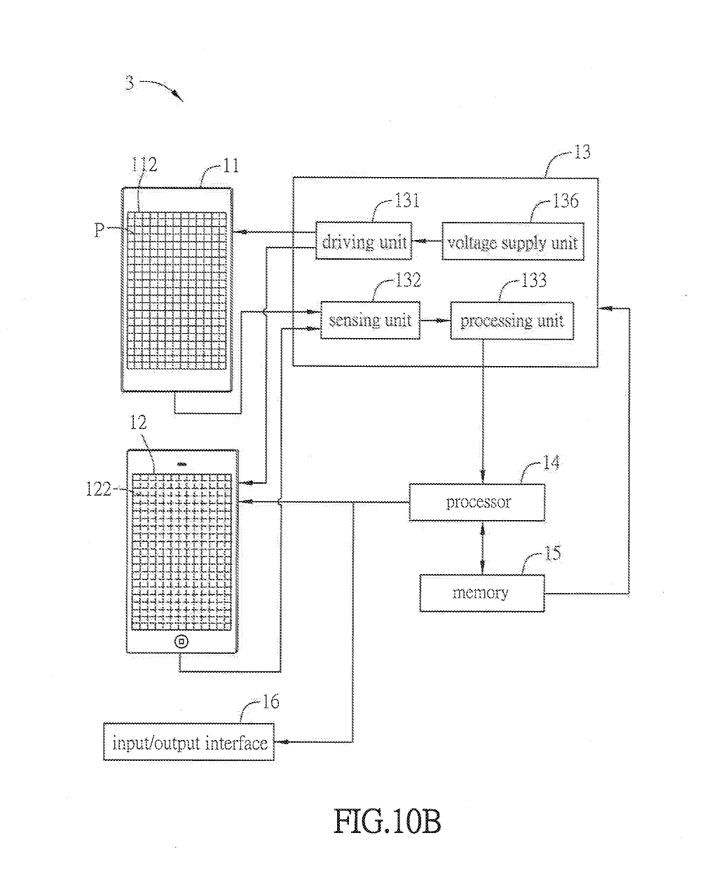

FIG. 10A is a block diagram of the hand-held electronic device of FIG. 1 according to another embodiment. The hand-held electronic device 2 is similar to the hand-held electronic device 1. The difference is that another touch-sensing structure 122 can also be disposed on the panel 12 in the embodiment, and the touch-sensing structure 122 is connected to the controller 13a. The connection relationship between the touch-sensing structure 122 and the controller 13a is the same as that between the touch-sensing structure 112 and the controller 13 mentioned above. Thus, the hand-held electronic device 2 can simultaneously receive the input actions from the touch-sensing structure 112 and/or the touch-sensing structure 122. The processor 14 can also execute a plurality of operations to achieve multi-input-multi-out (MIMO) and is compatible with the multi-input-multi-out (MIMO) required by 4G communication.

FIG. 10B is a block diagram of the hand-held electronic device of FIG. 1 according to another embodiment. The hand-held electronic device 3 in the embodiment is similar to the hand-held electronic device 2 in FIG. 10A. The difference is that the touch-sensing structure 122 and the touch-sensing structure 112 are connected to the same controller 13. The other descriptions can refer to the above embodiment.

Additionally, in some embodiments, the hand-held electronic device 1 further comprises a wireless communication unit. The wireless communication unit can comprise an infrared (IR) unit, a Bluetooth unit, a Zigbee unit, a radio frequency (RF) unit, or a near field communication (NFC) unit. The wireless communication unit has a wireless communication chip and an antenna. If the wireless communication unit of the hand-held electronic device 1 is the NFC unit, the NFC chip is electrically connected to the controller 13 and the antenna can be disposed on the cover 111 or the touch-sensing structure 112, which are not limited thereto. When the user want to wireless communicate with another electronic device by NFC, he can take the hand-held electronic device 1 close to another electronic device, which has NFC function, to receive data from or transmit data to another electronic device by the antenna and the NFC chip.

As mentioned above, as to the controller for the shadeless touch hand-held electronic device, the user can perform the touch operation on the touch-sensing cover of the hand-held electronic device, so the user's finger will not shade the view or the software item displayed on the panel, and the touch for opening the link of the high information density image will not be erroneously executed. The panel scratch can be reduced since operating the electronic device is performed on the touch-sensing cover. Furthermore, because the user can perform the touch operation on the touch-sensing cover, the user can use multiple fingers such as the forefinger and middle finger to operate the electronic device while using the same hand holding the device. In comparison with the conventional art where the user just can use the thumb to perform the operation while using the same hand holding the device, the disclosure can provide more manual efficiency and convenience and can realize a better user experience.

Furthermore, when the user uses the hand-held electronic device under the sunlight or the strong light source, he can hold the hand-held electronic device just by one hand and use the touch-sensing cover to block the sunlight or the strong light source. Due to the panel information resulting from the touch-sensing cover which blocks the sunlight or the strong light source, the sunlight visibility of the panel is improved, and it can be implemented without advanced display panel technique (for example OLED display panel or electric paper display panel).

Besides, in the hand-held electronic device, the trigger quantity, the trigger quantity distribution, the trigger morphology, the trigger time, the trigger frequency or the trigger location must firstly conform to the initiative determination condition, then the controller is permitted to perform various control on the hand-held electronic device (for example a multi-touch control, a volume control, a control for capturing images, taking pictures or recording, an unlock control, a control for turning on or turning off, a control for answering or rejecting phone call, a control for opening or closing application program, or a control for displaying content, etc.). Therefore, when other user uses the hand-held electronic device, because the trigger quantity, the trigger quantity distribution, the trigger morphology, the trigger time, the trigger frequency or the trigger location is distinct from the initiative determination condition which is predefined by the origin user, the hand-held electronic device is forbidden to operate so as to enhance the security of the hand-held electronic device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A controller, applied to a shadeless touch hand-held electronic device wherein the hand-held electronic device comprises a touch-sensing cover, a panel, the controller, a processor and a memory, the touch-sensing cover is disposed on one side of the hand-held electronic device opposite the panel, the touch-sensing cover comprises a cover and a touch-sensing structure, the touch-sensing structure comprises a plurality of detection points, the controller is connected to the touch-sensing structure by signaling, the memory stores an initiative determination condition, and the processor is connected to the controller by signaling, the controller comprising:
a driving unit, outputting a driving signal to the touch-sensing structure;
a sensing unit, receiving a trigger signal of a trigger event from the touch-sensing structure; and
a processing unit, receiving the trigger signal and computing the detection points of the trigger event to generate a computed result, and comparing the computed result with the initiative determination condition;
wherein, the processor executes an action for the hand-held electronic device if the trigger event conforms to the initiative determination condition.

2. The controller of claim 1, wherein the user uses the hand-held electronic device by one hand, and the touch-sensing cover faces a light source or the panel's back faces the light source.

3. The controller of claim 1, wherein an area of the touch-sensing structure and the area of the panel have a ratio relationship, and the controller converts an input position of the touch-sensing structure into a display position of the panel according to the ratio relationship.

4. The controller of claim 1, wherein the touch-sensing cover further comprises a wireless communication unit, the wireless communication unit comprises a wireless communication chip and an antenna, the wireless communication chip is electrically connected to the controller, and the antenna is disposed on the cover or the touch-sensing structure.

5. The controller of claim 1, wherein the action comprises a multi-touch control, a volume control, a control for capturing images, taking pictures or recording, an unlock control, a control for turning on or turning off, a control for answering or rejecting phone call, a control for opening or closing application program, or a control for displaying content performed on the hand-held electronic device.

6. The controller of claim 5, wherein the control for displaying content comprises a cursor moving, a screen rotation, a screen scrolling, a screen zooming, or a screen rebounding.

7. The controller of claim 1, wherein the controller is disposed on a circuit board.

8. The controller of claim 1, wherein the touch-sensing structure is capable of a wireless power transmission.

9. The controller of claim 1, wherein the touch-sensing structure comprises metal mesh, metal nanowires, transparent conducting film, carbon nanotube or graphene.

10. The controller of claim 1, further comprising:
a palmprint recognition unit, receiving a palmprint, wherein the processing unit compares the palmprint with a predefined palmprint pattern stored in the memory, and the processor converts the hand-held electronic device into a unlock state of user interface if the trigger event conforms to the initiative determination condition and the palmprint corresponds to the predefined palmprint pattern.

11. A controller, applied to a shadeless touch hand-held electronic device, wherein the hand-held electronic device comprises a touch-sensing cover, a panel, the controller and a memory, the touch-sensing cover is disposed on one side of the hand-held electronic device opposite the panel, the touch-sensing cover comprises a cover and a touch-sensing structure, the touch-sensing structure comprises a plurality of detection points, the controller is connected to touch-sensing structure, and the memory stores an initiative determination condition, the controller comprising:
a driving unit, outputting a driving signal to the touch-sensing structure; and
a sensing unit, receiving a trigger signal of a trigger event from the touch-sensing structure;
wherein the controller computes the detection points of the trigger event to generate a computed result according to the trigger signal, and compares the computed result with the initiative determination condition, the controller executes an action for the hand-held electronic device if the trigger event conforms to the initiative determination condition,

12. The controller of claim 11, wherein when the user uses the hand-held electronic device by one hand, and the touch-sensing cover faces a light source or the panel's back faces the light source.

13. The controller of claim 12, wherein the area of the touch-sensing structure and the area of the panel have a ratio relationship, and the controller converts an input position of the touch-sensing structure into a display position of the panel according to the ration relationship.

14. The controller of claim 11, wherein the touch-sensing cover further comprises a wireless communication unit, the wireless communication unit comprises a wireless communication integrated circuit and an antenna, the wireless communication integrated circuit is electrically connected to the controller, and the antenna is disposed on the cover or the touch-sensing structure.

15. The controller of claim 11, wherein the action comprises a multi-touch control, a volume control, a control for capturing images, taking pictures or recording, an unlock control, a control for turning on or turning off, a control for answering or rejecting phone call, a control for opening or closing application program, or a control for displaying content performed on the hand-held electronic device.

16. The controller of claim 15, wherein the control for displaying content comprises a cursor moving, a screen rotation, a screen scrolling, a screen zooming, or a screen rebounding.

17. The controller of claim 11, wherein the controller is disposed on a circuit board.

18. The controller of claim 11, wherein the touch-sensing structure is capable of a wireless power transmission.

19. The controller of claim 11, wherein the touch-sensing structure comprises metal mesh, metal nanowires, transparent conducting film, carbon nanotube or graphene.

20. The controller of claim 11, wherein the controller further comprises:
a palmprint recognition unit, receiving a palmprint, wherein the processing unit compares the palmprint with a predefined palmprint pattern stored in the memory, and the processor converts the hand-held electronic device into a unlock state of user interface if the trigger event conforms to the initiative determination condition and the palmprint corresponds to the predefined palmprint pattern.
